(19) United States
(12) Patent Application Publication
(10) Pub. No.: US 2026/0124818 A1
(43) Pub. Date: May 7, 2026

(54) LAMINATE WITH MACHINE DIRECTION ORIENTED MULTILAYER FILM

(71) Applicant: Dow Global Technologies LLC, Midland, MI (US)

(72) Inventors: Prem K. Chaturvedi, Navi Mumbai (IN); Nrusingh Sahu, Tarragona (ES); Nimisha Rahul Pathare, Navi Mumbai (IN); Martin Keith Hill, Tarragona (ES)

(21) Appl. No.: 19/119,913

(22) PCT Filed: Oct. 18, 2023
(86) PCT No.: PCT/US2023/035375

§ 371 Date: Apr. 10, 2025

(30) Foreign Application Priority Data
Oct. 18, 2022 (IN) 202241059403

(51) Int. Cl. B32B 7/02; B32B 7/12; B32B 27/08; B32B 27/32

(52) U.S. Cl. CPC B32B 7/02; B32B 7/12; B32B 27/08; B32B 27/32; B32B 2250/05; B32B 2250/242; B32B 2307/31; B32B 2307/516; B32B 2307/72

(57) ABSTRACT

The present disclosure provides a laminate. In an embodiment, the laminate comprises a first machine direction oriented (1MDO) multilayer film. The 1MDO multilayer film comprises (a) a skin layer comprising (i) a skin layer (SL) first ethylene/α-olefin copolymer having a density from 0.870 g/cc to 0.920 g/cc, and (ii) an optional skin layer (SL) second ethylene/α-olefin copolymer having a density from 0.900 g/cc to 0.980 g/cc. The 1MDO multilayer film comprises (b) a first intermediate layer in direct contact with the skin layer. The first intermediate layer comprises (i) a first intermediate layer (FIL) first ethylene/α-olefin copolymer having a density from 0.940 g/cc to 0.980 g/cc, and (ii) a first intermediate layer (FIL) second ethylene/a-olefin copolymer having density from 0.916 g/cc to 0.980 g/cc. The 1MDO multilayer film comprises (c) a core layer in direct contact with the first intermediate layer (b). The core layer (c) comprises (i) a core layer (CL) first ethylene/a-olefin copolymer having a density from 0.915 g/cc to 0.980 g/cc. The 1MDO multilayer film comprises (d) a second intermediate layer in direct contact with the core layer. The second intermediate layer comprises an ethylene-based polymer. The 1MD0 multilayer film comprises (e) an interior layer in direct contact with the second intermediate layer. The interior layer comprises an ethylene-based polymer. The laminate comprises a second machine direction oriented (2MDO) film and an adhesive layer between the 1MDO multilayer film and the 2MDO film.

### FIELD

The present disclosure relates to laminates, and more specifically, laminates comprising machine direction oriented multilayer films.

### BACKGROUND

Polyolefin films are widely used in flexible packaging, either as stand-alone packaging or lamination film. In an effort to improve recyclability and expand sustainability, the flexible packaging market is moving toward mono-material solutions based on ethylene-based polymers (commonly referred to “polyethylenes”). As such, efforts continue to downgauge polyethylene films in search of thinner, tougher, stiffer and lower cost solutions for flexible packaging.

Machine direction oriented (MDO) film is one approach for downgauging polyethylene and providing stiffness and optical properties to film. However, when oriented in the machine direction, polyethylene-based film can become weak in tear strength in the machine direction due to the unidirectional orientation. Polyethylene in films therefore is often blended with one or more non-polyethylene resins, or polyethylene films are often laminated with another non-polyethylene film (e.g., polyethylene terephthalate, polypropylene film) to achieve desirable physical film properties. Films including polyethylene and non-polyethylene resins, however, can be difficult or impossible to recycle. Likewise, while oriented polypropylene laminates with cast polypropylene structures may provide some desirable properties in packages, such laminates are not easily recyclable.

Consequently, the art recognizes the need for laminates and MDO multilayer film comprising polyethylene that can be recycled and provide suitable tear strength, stiffness, optics, and heat sealability for flexible packaging applications.

### SUMMARY

The present disclosure provides a laminate. In an embodiment, the laminate comprises a first machine direction oriented (1MDO) multilayer film. The 1MDO multilayer film comprises (a) a skin layer comprising (i) a skin layer (SL) first ethylene/α-olefin copolymer having a density from 0.870 g/cc to 0.920 g/cc, and (ii) an optional skin layer (SL) second ethylene/α-olefin copolymer having a density from 0.900 g/cc to 0.980 g/cc. The 1MDO multilayer film comprises (b) a first intermediate layer in direct contact with the skin layer. The first intermediate layer comprises (i) a first intermediate layer (FIL) first ethylene/α-olefin copolymer having a density from 0.940 g/cc to 0.980 g/cc, and (ii) a first intermediate layer (FIL) second ethylene/α-olefin copolymer having density from 0.916 g/cc to 0.980 g/cc. The 1MDO multilayer film comprises (c) a core layer in direct contact with the first intermediate layer (b). The core layer (c) comprises (i) a core layer (CL) first ethylene/α-olefin copolymer having a density from 0.915 g/cc to 0.980 g/cc. The 1MDO multilayer film comprises (d) a second intermediate layer in direct contact with the core layer. The second intermediate layer comprises an ethylene-based polymer. The 1MDO multilayer film comprises (e) an interior layer in direct contact with the second intermediate layer. The interior layer comprises an ethylene-based polymer. The laminate comprises a second machine direction oriented (2MDO) film and an adhesive layer between the 1MDO multilayer film and the 2MDO film.

### Definitions

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, al parts and precents are based on weight and all test methods are current as of the filing date of this disclosure.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be affected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination.

The term “direct contact,” or “directly contacts,” or “is in direct contact with,” or similar terms refers to a layer configuration whereby a first layer is located immediately adjacent to a second layer and no intervening layers or no intervening structures are present between the first layer and the second layer.

“Polyethylene” or “ethylene-based polymer” is a polymer comprising a majority amount (greater than 50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); single-site catalyzed, Linear Low Density Polyethylene, including both linear and substantially linear low density resins (m-LLDPE); ethylene-based plastomers (POP) and ethylene-based elastomers (POE); Medium Density Polyethylene (MDPE); and High Density Polyethylene (HDPE). The following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range from 0.916 g/cm³ to 0.935 g/cm³.

The term “LLDPE”, includes both resin made using the traditional Ziegler-Natta catalyst systems and chromium-based catalyst systems as well as single-site catalysts, including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy), and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization or any combination thereof, using any type of reactor or reactor configuration.

The term “MDPE” refers to polyethylenes having densities from 0.926 g/cm³ to 0.935 g/cm³. “MDPE” is typically made using chromium or Ziegler-Natta catalysts or using single-site catalysts including, but not limited to, substituted mono- or bis-cydopentadienyl catalysts (typically referred to as metallocene), constrained geometry catalysts, pyridylamine catalysts, phosphinimine catalysts & polyvalent aryloxyether catalysts (typically referred to as bisphenyl phenoxy), and typically have a molecular weight distribution (“MWD”) greater than 2.5.

The term “HDPE” refers to polyethylenes having densities from 0.935 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy).

The term “ULDPE” refers to polyethylenes having densities of 0.855 to 0.912 g/cm³, which are generally prepared with Ziegler-Natta catalysts, chrome catalysts, or single-site catalysts including, but not limited to, substituted mono- or bis-cyclopentadienyl catalysts (typically referred to as metallocene), constrained geometry catalysts, pyridylamine catalysts, phosphinimine catalysts & polyvalent aryloxyether catalysts (typically referred to as bisphenyl phenoxy). ULDPEs include, but are not limited to, polyethylene (ethylene-based) plastomers and polyethylene (ethylene-based) elastomers. Polyethylene (ethylene-based) elastomers plastomers generally have densities of 0.855 g/cm³ to 0.912 g/cm³.

The term “ethylene monomer,” or “ethylene,” as used herein, refers to a chemical unit having two carbon atoms with a double bond therebetween, and each carbon bonded to two hydrogen atoms, wherein the chemical unit polymerizes with other such chemical units to form an ethylene-based polymer composition.

A “heteroatom” is an atom other than carbon or hydrogen. The heteroatom can be a non-carbon atom from Groups IV, V, VI and VII of the Periodic Table. Nonlimiting examples of heteroatoms include: F, N, O, P, B, S, and Si.

A “hydrocarbon” is a compound containing only hydrogen atoms and carbon atoms. A “hydrocarbonyl” (or “hydrocarbonyl group”) is a hydrocarbon having a valence (typically univalent). A hydrocarbon can have a linear structure, a cyclic structure, or a branched structure.

A “laminate,” as used herein, includes a first film structure, a second film structure, and an adhesive layer between the first film structure and the second film structure. The first film structure and/or the second film structure can be a monolayer film or a multilayer film.

A “machine direction oriented film” or “MDO film” is a film stretched (or oriented) in the machine direction at a draw ratio from 4:1 to 12:1. The MDO film is a uniaxially oriented film. The stretching or orienting of the film is performed byway of machine direction orientation rolls, via tentering, or via intermeshing gears whereby the film is ring rolled, or otherwise incrementally stretched in the machine direction and below the melting point of the film.

A “multilayer structure” is a structure having more than one layer. For example, the multilayer structure may have two, three, four, five or more layers. A multilayer structure may be described as having the layers designated with letters. For example, a three layer structure having a core layer B, and two external layers A and C may be designated as A/B/C.

An “olefin” is an unsaturated, aliphatic hydrocarbon having a carbon-carbon double bond.

An “olefin-based polymer” (interchangeably referred to as “polyolefin”) is a polymer that contains a majority weight percent of polymerized olefin monomer (based on the total amount of polymerizable monomers), and optionally, may contain at least one comonomer. Nonlimiting examples of olefin-based polymer include ethylene-based polymer and propylene-based polymer.

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” (interchangeably referred to as“polypropylene”) isa polymer that contains more than 50 mole percent polymerized propylene monomer (based on the total amount of polymerizable monomers) and, optionally, may contain at least one comonomer. Propylene-based polymer includes propylene homopolymer, and propylene copolymer (meaning units derived from propylene and one or more comonomers). The terms “propylene-based polymer” and “polypropylene” may be used interchangeably. A nonlimiting example of a propylene-based polymer (polypropylene) is a propylene/α-olefin copolymer with at least one C₂ or C₄-C₁₀ α-olefin comonomer.

### DETAILED DESCRIPTION

The present disclosure provides a laminate. In an embodiment, the laminate includes
a first machine direction-oriented multilayer (1MDO) film adhered to a second machine direction oriented (2MDO) film. The 1MDO multilayer film includes (a) a skin layer (“SL”), (b) a first intermediate layer (“FIL”), (c) a core layer (“CL”), (d) a second intermediate layer (“SIL”), and (e) an interior layer (“IL”). The skin layer (a) includes (I) an SL first ethylene/α-olefin copolymer having a density from 0.870 g/cc to 0.920 g/cc, and (ii) an optional SL second ethylene/α-olefin copolymer having a density from 0.900 g/cc to 0.980 g/cc. The first intermediate layer (b) is in direct contact with the skin layer (a), and the first intermediate layer (b) includes (i) a FIL first ethylene/α-olefin copolymer having a density from 0.940 g/cc to 0.980 g/cc, and (ii) a FIL second ethylene/α-olefin copolymer having a density from 0.916 g/cc to 0.980 g/cc. The core layer (c) is in direct contact with the first intermediate layer (b). The core layer (c) includes (i) a CL first ethylene/α-olefin copolymer having a density from 0.900 g/cc to 0.920 g/cc. The second intermediate layer (d) is in direct contact with the core layer (c). The second intermediate layer (d) includes an ethylene-based polymer. The interior layer (e) is in direct contact with the second intermediate layer (d). The interior layer (e) includes an ethylene-based polymer.

Although the 1MDO film is oriented in the machine direction, it is understood the 1MDO film could be further oriented in the transverse (or cross) direction and be a bi-axially oriented film.

Each of the following terms and respective abbreviation are used interchangeably: skin layer (or SL), first intermediate layer (or FIL), core layer (or CL), second intermediate layer (or SIL), and interior layer (or IL). Each ethylene-based polymer (and/or each ethylene/α-olefin copolymer) is a hydrocarbon. The ethylene-based polymers disclosed herein are identified by location, namely, identified by the film layer in which the ethylene-based polymer resides. It is understood that an ethylene-based polymer present in a first layer (i.e., present in the skin layer or SL) may or may not be the same ethylene-based polymer that is present in a second layer (i.e., present in the core layer or CL). The term “different than” as it relates to ethylene-based polymers (or ethylene/α-olefin copolymers) indicates that an ethylene-based polymer has at least one property or property value dissimilar to the corresponding property in another ethylene-based polymer. Nonlimiting examples of ethylene-based polymer (or ethylene/α-olefin copolymer) properties include comonomer type, comonomer amount, density, melt index, and/or melt temperature. Byway of example, a first ethylene/α-olefin copolymer that is “different than” a second ethylene/α-olefin copolymer may have a density value that is dissimilar to the density value of the second ethylene/α-olefin copolymer.

In an embodiment, the comonomer for ethylene/α-olefin copolymer is a C₃-C₁₂ α-olefin, or a C₄-C₁₀ α-olefin, or a C₄-C₈ α-olefin. In a further embodiment, the comonomer is butene, hexene, or octene.

### 1. First MDO Multilayer Film

The laminate includes the 1MDO multilayer film comprising the skin layer (a). The skin layer (a) is an outermost layer for the laminate. The skin layer (a) can be a seal layer. The skin layer (a) comprises (i) the SL first ethylene/α-olefin copolymer, (ii) an optional SL second ethylene/α-olefin copolymer, and (iii) optional additives. The SL first ethylene/α-olefin copolymer has a density from 0.870 g/cc to 0.920 g/cc, or from 0.900 g/cc to 0.920 g/cc. The SL first ethylene/α-olefin copolymer can have a melt index from 0.5 g/10 min to 1.5 g/10 min, and a melt temperature from 55° C. to 125° C., or from 120° C. to 125° C. When present, the SL second ethylene/α-olefin copolymer can have a density from 0.900 g/cc to 0.980 g/cc, or from 0.920 g/cc to 0.980 g/cc, or from 0.900 g/cc to 0.935 g/cc, or from 0.900 g/cc to 0.920 g/cc, a melt index from 0.5 g/10 min to 1.5 g/10 min, and a melt temperature from 95° C. to 135° C., or from 95° C. to 105° C., or from 120° C. to 135° C. In an embodiment, the skin layer (a) comprises from 50 wt % to 80 wt %, or from 50 wt % to 70 wt %, or from 55 wt % to 65 wt % of the SL first ethylene/α-olefin copolymer and from 50 wt % to 20 wt %, or from 50 wt % to 30 wt %, or from 40 wt % to 30 wt % of the SL second ethylene/α-olefin copolymer. Weight percent is based on total weight of the skin layer (a). It is understood weight percent amounts to 100 weight percent for skin layer (a). With respect to film layer weight percent, it is further understood weight percent amounts to 100 weight percent for each forthcoming layer disclosed herein.

The laminate includes the 1MDO multilayer film comprising the first intermediate layer (b). The first intermediate layer (b) is in direct contact with the skin layer (a). The first intermediate layer (b) comprises (i) the FIL first ethylene/α-olefin copolymer, (ii) the FIL second ethylene/α-olefin copolymer, and (iii) optional additives. The FIL first ethylene/α-olefin copolymer is different than the FIL second ethylene/α-olefin copolymer. The FIL first ethylene/α-olefin copolymer has a density from 0.940 g/cc to 0.980 g/cc, or from 0.940 g/cc to 0.950 g/cc. The FIL first ethylene/α-olefin copolymer can have a melt index from 0.5 g/10 min to 1.5 g/10 min, and a melt temperature from 125° C. to 135° C., or from 125° C. to 130° C. The first intermediate layer (b) also contains (ii) the FIL second ethylene/α-olefin copolymer, the FIL second ethylene/α-olefin copolymer has a density from 0.916 g/cc to 0.980 g/cc, or from 0.940 g/cc to 0.980 g/cc, or from 0.960 g/cc to 0.980 g/cc. The FIL second ethylene/α-olefin copolymer can have a melt index from 0.5 g/10 min to 1.5 g/10 min, and a melt temperature from 125° C. to 135° C., or from 130° C. to 135° C. In an embodiment, the first intermediate layer comprises from 40 wt % to 80 wt %, or from 50 wt % to 70 wt %, or from 50 wt % to 60 wt % of the FIL first ethylene/α-olefin copolymer and from 60 wt % to 20 wt %, or from 50 wt % to 30 wt %, or from 50 wt % to 40 wt % of the FIL second ethylene/α-olefin copolymer. Weight percent is based on total weight of the first intermediate layer (b).

The laminate includes the 1MDO multilayer film comprising the core layer (c). The core layer (c) is in direct contact with the first intermediate layer (b). The core layer (c) comprises (i) the CL first ethylene/α-olefin copolymer, (ii) an optional CL second ethylene/α-olefin copolymer, and (iii) optional additives. The CL first ethylene/α-olefin copolymer has a density from 0.915 g/cc to 0.980 g/cc, or from 0.900 g/cc to 0.920 g/cc, or from 0.910 g/cc to 0.920 g/cc. The CL first ethylene/α-olefin copolymer can have a melt index from 0.5 g/10 min to 1.5 g/10 min, and a melt temperature from 120° C. to 135° C., or from 120° C. to 125° C.

In an embodiment, the core layer (c) includes (i) the CL first ethylene/α-olefin copolymer, (ii) the CL second ethylene/α-olefin copolymer, and (iii) optional additives. The CL first ethylene/α-olefin copolymer is different than the CL second ethylene/α-olefin copolymer. The CL first ethylene/α-olefin copolymer has a density from 0.915 g/cc to 0.980 g/cc, or from 0.900 g/cc to 0.920 g/cc, or from 0.910 g/cc to 0.920 g/cc, and can have a melt index from 0.5 g/10 min to 1.5 g/10 min, and a melt temperature from 120° C. to 135° C., or from 120′C to 125° C. The core layer (c) also contains (ii) the CL second ethylene/α-olefin copolymer. The CL second ethylene/α-olefin copolymer has a density from 0.940 g/cc to 0.980 g/cc, or from 0.940 g/cc to 0.950 g/cc, and can have a melt index from 0.5 g/10 min to 1.5 g/10 min, and a melt temperature from 125° C. to 135° C., or from 125° C. to 130° C. In a further embodiment, the core layer (c) comprises from 10 wt % to 50 wt %, or from 10 wt % to 40 wt %, or from 20 wt % to 40 wt % of the CL first ethylene/α-olefin copolymer and from 90 wt % to 50 wt %, or from 90 wt % to 60 wt %, or from 80 wt % to 60 wt % of the CL second ethylene/α-olefin copolymer. Weight percent is based on total weight of the core layer (c).

The laminate includes the 1MDO multilayer film comprising the second intermediate layer (d). The second intermediate layer (d) is in direct contact with the core layer (c). The second intermediate layer (d) comprises (i) one or more ethylene-based polymers, and (ii) optional additives. The second intermediate layer (d) may include (i) a SIL first ethylene/α-olefin copolymer, (ii) an optional SIL second ethylene/α-olefin copolymer, and (Ill) optional additives.

In an embodiment, the second intermediate layer (d) includes (i) the SIL first ethylene/α-olefin copolymer, (ii) the SIL second ethylene/α-olefin copolymer, and (iii) optional additives. The SIL first ethylene/α-olefin copolymer has a density from 0.900 g/cc to 0.920 g/cc, or from 0.910 g/cc to 0.920 g/cc, and can have a melt index from 0.5 g/10 min to 1.5 g/10 min, and a melt temperature from 120° C. to 125° C. The second intermediate layer (d) also contains (ii) the SIL second ethylene/α-olefin copolymer. The SIL second ethylene/α-olefin copolymer has a density from greater than or equal to 0.940 g/cc to 0.980 g/cc, or from 0.940 g/cc to 0.950 g/cc, and can have a melt index from 0.5 g/10 min to 1.5 g/10 min, and a melt temperature from 125° C. to 135° C., or from 125° C. to 130° C. In a further embodiment, the second intermediate layer (d) comprises of from 10 wt % to 50 wt %, or from 20 wt % to 40 wt %, or from 30 wt % to 40 wt % of the SIL first ethylene/α-olefin copolymer and from 90 wt % to 50 wt %, or from 80 wt % to 60 wt %, or from 70 wt % to 60 wt % of the SIL second ethylene/α-olefin copolymer. Weight percent is based on total weight of the second intermediate layer (d). In a further embodiment, the composition of the second intermediate layer (d) is the same as, or is identical to, the composition of the core layer (c).

The laminate includes the 1MDO multilayer film comprising the interior layer (e). The interior layer (e) is the interface with the adhesive layer. The interior layer (e) comprises (i) (one or more) ethylene-based polymers and (ii) optional additives. The interior layer (e) may include (i) an IL first ethylene/α-olefin copolymer, (ii) an optional IL second ethylene/α-olefin copolymer, and (iii) optional additives. The IL first ethylene/α-olefin has a density from 0.940 g/cc to 0.980 g/cc.

In an embodiment, the interior layer (e) includes (i) the IL first ethylene/α-olefin copolymer, (ii) the IL second ethylene/α-olefin copolymer, and (iii) optional additives. The IL first ethylene/α-olefin copolymer has a density from 0.940 g/cc to 0.980 g/cc, or from 0.960 g/cc to 0.980 g/cc, and can have a melt index from 0.5 g/10 min to 1.5 g/10 min, and a melt temperature from 130° C. to 135° C. The interior layer (e) also includes the IL second ethylene/α-olefin copolymer. The IL second ethylene/α-olefin copolymer has a density from 0.900 g/cc to 0.920 g/cc, or from 0.910 g/cc to 0.920 g/cc, and can have a melt index from 0.5 g/10 min to 1.5 g/10 min, and a melt temperature from 95° C. to 125° C., or from 120° C. to 125° C. In a further embodiment, the interior layer (e) comprises 50 wt % to 90 wt %, or from 60 wt % to 80 wt %, or from 65 wt % to 75 wt % of the IL first ethylene/α-olefin copolymer and from 50 wt % to 10 wt %, or from 40 wt % to 20 wt %, or from 35 wt % to 25 wt % of the IL second ethylene/α-olefin copolymer. Weight percent is based on total weight of the interior later (e).

The 1MDO multilayer film includes the skin layer (a) which is an outermost layer for the laminate and can be a seal layer. The intermediate layer (b) is in-between and in direct contact with the skin layer (a) and the care layer (c). The core layer (c) is in-between and in direct contact with the first intermediate layer (b) and the second intermediate layer (d). The second intermediate layer (d) is in-between and in direct contact with the core layer (c) and the interior layer (e). Interior layer (e) is an outermost layer for the MDO multilayer film and is the interface with the adhesive layer. The MDO1 multilayer film has a thickness from 10 microns to 50 microns, or from 15 micron to 40 microns, or from 20 microns, to 30 microns, or 25 microns. Each layer in the 1MDO multilayer film can comprise solely, or consist solely, one or more ethylene-based polymers (and optional additives). In an embodiment, the 1MDO multilayer film comprises at least 95 wt %, or at least 97 wt %, or at least 99 wt % ethylene-based polymers, based on the total weight of the 1MDO multilayer film. In a further embodiment, the 1MDO multilayer film consists of, or consists essentially of, ethylene-based polymers (and optional additives).

### 2. Second MDO Film

The laminate includes a second machine direction oriented (2MDO) film. The 2MDO film can be a monolayer film or a multilayer film. When the 2MDO is a multilayer film, the 2MDO can have two, or three, or four, or five, or six, or seven, or eight, or nine, or more layers. Although the 2MDO film is oriented in the machine direction, it is understood the 2MDO film could be further oriented in the transverse (or cross) direction and be a bi-axially oriented film.

In an embodiment, the 2MDO film is a multilayer film and includes an outermost layer (Interchangeably referred to as “ol”) comprising (I) an (ol) first ethylene/α-olefin copolymer having a density from 0.935 g/cc to 0.980 g/cc, or from 0.940 g/cc to 0.980 g/cc, (ii) an optional (ol) second ethylene/α-olefin copolymer, and (iii) optional additives. The laminate includes an adhesive layer in-between and in direct contact with the inner layer (e) of the 1MDO multilayer film and the outermost layer of the 2MDO multilayer film.

In an embodiment, the 2MDO film is a multilayer film and includes the outermost layer (ol), an outer middle layer (interchangeably referred to as “om”) in direct contact with the outer layer (ol), a middle layer (interchangeably referred to as “ml”) in direct contact with the outer middle layer (om), an inner middle layer (interchangeably referred to as “im”) in direct contact with the middle layer (ml), and an inner layer (interchangeably referred to as “in”) in direct contact with the inner middle layer (im). The 2MDO multilayer film has an unblocked layer configuration ol/om/ml/im/in or a blocked layer configuration ol/om/ml/im/in/in/im/ml/om/ol. Each layer in the 2MDO multilayer film can comprise solely of, or consist solely of, one or more ethylene-based polymers (and optional additives). In an embodiment, the 2MDO film comprises at least 95 wt %, or at least 97 wt %, or at least 99 wt % ethylene-based polymers, based on the total weight of the 2MDO film. In an embodiment, the 2MDO film consists of, or consists essentially of, ethylene-based polymers (and optional additives). The 2MDO multilayer film has a thickness from 10 microns to 50 microns, or from 15 micron to 40 microns, or from 20 microns to 30 microns, or 25 microns.

### 3. Additives

Each layer in the 1MDO multilayer film and/or in the 2MDO multilayer film may include one or more optional additives. Nonlimiting examples of suitable additive include antioxidants, such as IRGANOX 1010 and IRGAFOS 168 (commercially available from BASF), ultraviolet light absorbers, antistatic agents, pigments, dyes, nucleating agents, fillers, slip agents, fire retardants, plasticizers, polymer processing aids (PPA), lubricants, stabilizers, smoke inhibitors, viscosity control agents, surface modification agents, and anti-blocking agents. When present, the additive(s) amount(s) to greater than 0 wt % to 5 wt %, or from 0.01 wt % to 4 wt %, or from 0.05 wt % to 3 wt %, or from 0.01 wt % to 1.0 wt %, or from 0.05 wt % to 1.0 wt % of the MDO multilayer film layer. Weight % is based on total weight of the respective film layer containing the additive(s).

### 4. Adhesive Layer

The laminate includes an adhesive layer. The adhesive layer is in-between the interior layer (e) of the 1MDO multilayer film and the outermost layer (ol) of the 2MDO multilayer film such that the adhesive layer is in direct contact with the interior layer (e) and is in direct contact with the outermost layer (ol). The adhesive layer bonds, or otherwise adheres, the 1MDO film to the 2MDO film. Nonlimiting examples of suitable adhesive material for the adhesive layer include solvent-based adhesives, solvent-less adhesives, aqueous adhesives, polyurethane, epoxy, acrylic, extruded polyethylene or the like. In an embodiment, the laminate includes an adhesive layer composed of a polyurethane adhesive. The adhesive may be solvent free, waterborne or solvent based. Furthermore, the adhesive may be a one or two part formulation. The two parts crosslink, or otherwise bond, the 1MDO multilayer film with 2MDO film. The adhesive layer has a coating weight from 1 gram per square meter (gsm) to 5 gsm.

The term “heat seal conditions,” as used herein, is the provision of arranging two separate laminates such that two skin layers (a) are opposed to each other and are in contact with each other (hereafter interchangeably referred to as “a first skin layer (a) in contact with a second skin layer (a)”). The two laminates are placed between opposing heat seal bars, the heat seal bars are moved toward each other, sandwiching the two laminates, to apply heat and pressure to the two laminates such that the opposing skin layers (a) contact, melt, and form a heat seal, or weld, attaching the two laminates together. Heat sealing includes suitable structure and mechanism to move the seal bars toward and away from each other in order to perform the heat sealing procedure. The heat seal conditions further include applying a pressure of 2.5 Kg/cm² (“seal pressure”) on the two laminates for a 0.5 seconds dwell time (“dwell”) at temperatures ranging from 85° C. to 130° C. with 5° C. increments (“seal temperature”) in accordance with ASTM F88. Heat seal strength is reported as average peak load (in Kg/25 mm) for each respective temperature.

In an embodiment, the laminate forms a heat seal having a heat seal strength of greater than or equal to 0.3 Kg/25 mm, or from 0.3 to 0.8 Kg/25 mm, or from 0.5 to 0.8 Kg/25 mm under the heat seal conditions seal pressure, 0.5 seconds dwell time, and 95° C. seal temperature. In an embodiment, the laminate comprises at least 95 wt %, or at least 97 wt %, or at least 99 wt % ethylene-based polymers, based on the total weight of the laminate.

### Test Methods

Density is measured in accordance with ASTM D792, Method B. Results are reported in grams per cubic centimeter (g/cc or g/cm³).

Heat Seal Initiation Temperature and Seal Strength. To determine heat seal Initiation temperature (HSIT) and seal strength, samples are sealed by a heat sealing device with opposing seal jaws. The sample width is 25 mm, the dwell seal time is 0.5 seconds for thickness less than 100 microns, and the seal pressure is 2.5 kg/cm². Heat sealed samples are conditioned for 24 hours and then measured using a tensile machine, equipped with a 100 N load cell, and at a pulling speed of 500 mm/min. HSIT is reported as a minimum temperature in degrees Celsius to obtain 0.3 Newton (0.3 Kg) seal strength force. Seal Strength values are reported in Kg/25 mm.

Heat Seal Strength. Heat seal strength, or seal strength was measured in accordance with ASTM F88. The values are reported in Kg/25 mm.

Melt index (I₂ or MI) is measured in accordance with ASTM D-1238 at 190° C. at 2.16 kg. The values are reported in g/10 min, which corresponds to grams eluted per 10 minutes.

Melt temperature. The differential scanning calorimetry (DSC) measurements were performed on a Differential Scanning Calorimeter. The samples (^{˜}3 mg) were loaded into aluminum calorimetry pans and heated from −40° C. to 150° C. at a heating rate of 10° C./min under Nitrogen atmosphere. Samples were exposed to one full heating and cooling cycle to remove any thermal history before measurement.

By way of example, and not limitation, examples of the present disclosure are provided.

### Examples

The materials used in comparatives samples (CS) and inventive examples (IE) are provided in Table 1.

TABLE 1
Materials

| Component | | Details | Source |
|---|---|---|---|
| 1^{st} MDO film | * | | |
| AFFINITY ™ 2.0 | SK2 | Ethylene-octene copolymer, density 0.904 g/cc, MI 1.0 | The Dow Chemical |
| | | g/10 min, Tm 100° C. | Company |
| AFFINITY ™ PL 1880G | | Ethylene-octene copolymer, density 0.902 g/cc, MI 1.0 | The Dow Chemical |
| | | g/10 min, Tm 99° C. | Company |
| AFFINITY ™ PL 1881G | SK2 | Ethylene/octene copolymer, density 0.904 g/cc, MI 1.0, | The Dow Chemical |
| | | Tm 100° C. | Company |
| AFFINITY ™ PL 8100G | | Ethylene/octene copolymer, density 0.870 g/cc, MI 1.0, | The Dow Chemical |
| | | Tm 55° C. | Company |
| DOWLEX ™ 2038.68 | om2 | LLDPE ethylene/octene copolymer, density 0.935 g/cc, | The Dow Chemical |
| | | MI1.0 g/10 min, Tm 126° C. | Company |
| ELITE ™ 5400GS | CL1 | Ethylene-octene copolymer, density 0.916 g/cc, MI 1.0 | The Dow Chemical |
| | | g/10 min, Tm 123° C. | Company |
| ELITE ™ 5401GT | SK1 | Ethylene-octene copolymer, density 0.918 g/cc, MI 1.0 | The Dow Chemical |
| | | g/10 min, Tm 123° C. | Company |
| ELITE ™ 5940ST | FIL1 | Ethylene-octene copolymer, density 0.940 g/cc, MI | The Dow Chemical |
| | | 0.85 g/10 min, Tm 126° C. | Company |
| ELITE ™ 5960G1 | FIL2 | Ethylene-octene copolymer, density 0.962 g/cc, MI | The Dow Chemical |
| | | 0.85 g/10 min, Tm 134° C. | Company |
| ELITE ™ AT 6900 | FIL2 | Ethylene/octene copolymer density 0.969 g/cc, MI 1.2 | The Dow Chemical |
| | | g/10 min, Tm 134° C. | Company |
| PPA | | Masterbatch with 5 wt % fluoroelastomer process aid | |
| | | (wt % based on total wt masterbatch) | |
| Slip agent | | Masterbatch with 5 wt % erucamide (wt % based on | |
| | | total wt masterbatch) | |
| Adhesive | | SB-ADCOTE ™545EA -- is a solvent-borne adhesive. | |
| Adhesive | | SL-MORFREE ™899A/C99 - is a solventless adhesive | |
| Cat F | | Coreactant -F854 | |

* A nonlimiting example of the ethylene/α-olefin copolymer identified by the layer and number.

### Fabrication of MDO Films

### 1. First MDO Multilayer Film (Heat Sealable MDO Film)

Two multilayer films, each with layer configuration a/b/c/d/e and 1/1/1/1/1 layer ratio were created on a Windmoller & Holscher coextrusion device. The two heat sealable MDO films are designated “MDO-PE (HS-1)” and “MDO-PE (HS-2)” as shown in Table 2 below.

TABLE 2

| Layers | MDO-PE (HS-1) | MDO-PE (HS-2) |
|---|---|---|
| Skin (SK) | 56% ELITE ™ 5401GT + 30% AFFINITY ™ PL 1881G + 3% | 61% ELITE ™ 5401GT + 40% |
| | Slip + 1% PPA | AFFINITY ™ 2.0 + 3% Slip + 1% PPA |
| 1^{st} intermediate | 40% ELITE ™ AT 6900 + 57% ELITE ™ 5940ST + 3% Slip | 40% ELITE ™ 5960 + 57% ELITE ™ |
| (FIL) | | 5940ST + 3% Slip |
| Core (CL) | 70% ELITE ™ 5940ST + 30% ELITE ™ 5400GS | 70% ELITE ™ 5940ST + 30% |
| | | ELITE ™5400GS |
| 2^{nd} intermediate | 70% ELITE ™ 5940ST + 30% ELITE ™ 5400GS | 70% ELITE ™ 5940ST + 30% ELITE ™ |
| (SIL) | | 5400GS |
| Interior (IL) | 74% ELITE ™ AT 6900 + 25% ELITE ™5400GS + 1% PPA | 74% ELITE ™ 5960 + 25% ELITE ™ |
| | | 5400GS + 1% PPA |

Wt % - based on total weight for each respective layer

The original thickness of each primary multilayer film IE1 and IE2 (pre-orientation) was 125 microns. Each primary multilayer film was stretched in a MDO unit roller, preheating temperature from 100° C. to 110° C., stretching temperature from 110° C. to 115° C., annealing temperature from 105° C. to 110° C., cooling roll temperature from 80° C. to 85° C. and 40° C.-45° cat a draw ratio of 5:1 to produce MDO multilayer film (1MDO) with a final thickness of 25 microns (output: 1000 kg/hr).

### 2. Second MDO Film (Print Film)

For the production of the second MDO film, a Windmoller & Holscher 5 Layer blown coextrusion device created a blocked multilayer film with layer configuration ol/om/ml/im/in/in/im/ml/om/ol and layer ratio 1/1/1/1/2/1/1/1/1 as shown in Table 3A below.

TABLE 3A
Blocked film, layer configuration ol/om/m/im/in/in/im/ml/om/ol

| | 3A Film Structure Formulation |
|---|---|
| Layers | (“MDO block A”) |
| (ol) Outer | 100% ELITE ™AT6900 (or 100% 5960G1) |
| (om) Outer | 100% ELITE5940ST (or 100% DOWLEX ™2038.68) |
| Middle | |
| (ml) Middle | 70% Elite 5940ST + 30% Elite 5400G |
| (im)Inner | 100% Elite 5940ST |
| Middle | |
| (in) Inner | 80% AFFINITY ™ EG8100G + |
| | 20% AFFINITY ™1880G |

Weight percent based on total weight for each respective layer

A Windmoller & Holscher 5 Layer blown coextrusion device created an unblocked multilayer film with layer configuration o/om/m/im/i and layer ratio 1/1/1/1/1 as shown in Table 3B below.

TABLE 3B
unblocked film, layer configuration ol/om/ml/im/in

| | 3B Film Structure Formulation |
|---|---|
| Layers | (“MDO unblocked B”) |
| (ol) Outer | 100% ELITE ™AT6900 (or 100% ELITE ™5960G1) |
| (om) Outer | 100% ELITE5940ST (or 100% DOWLEX ™2038.68) |
| Middle | |
| (ml) Middle | 70% Elite 5940ST + 30% Elite 5400G |
| (im) Inner | 100% Elite 5940ST |
| Middle | |
| (in) Inner | 100% ELITE ™AT6900 (or 100% ELITE ™5960G1) |

Weight percent based on total weight for each respective layer

The original thickness of each primary multilayer film 3A and 3B was 130 microns. Each primary film was stretched in a MDO unit roller, preheating temperature from 105° C. to 110° C., stretching temperature from 110° C. to 120° C., annealing temperature from 105° C. to 120° C., cooling roll temperature from 80° C. to 85° C. and 40′C-45° C. at a draw ratio of 6.5:1 to produce MDO multilayer film with a final thickness of 20 microns (2MDO). MDO multilayer film 3A (from Table 3A) is a blocked film (hereafter “MDO block A”). MDO multilayer film 3B (from Table 3B) is an unblocked film (hereafter “MDO unblocked B”).

### 3. Fabrication of Laminate

Laminates were prepared with solvent free (SF) and solvent base (SB) lamination process using SF adhesive MORFREE™ 899A/C99, SB adhesive—ADCOTE™ 545EA/COREACTANT F Adhesive by using K Bar coated and hot roll laminator.

TABLE 4
Seal strength (in Kg/25 mm) for laminate structures at varying temperatures

| | Laminate structure | 85° C. | 90° C. | 95° C. | 100° C. | 105° C. | 110° C. | 115° C. | 120° C. | 125° C. | 130° C. |
|---|---|---|---|---|---|---|---|---|---|---|---|
| IE1 | MDO blockA//MDO-PE (HS-1) | 0.034 | 0.075 | 0.51 | 0.73 | 0.95 | 1.03 | 1.15 | 1.29 | 2.56 | 2.91 |
| | SL-MORFREE ™899A/C99 | | | | | | | | | | |
| IE2 | MDO blockA//25 μm MDO-PE | 0.054 | 0.089 | 0.73 | 0.95 | 1.1 | 1.23 | 1.38 | 1.44 | 2.86 | 3.74 |
| | (HS-2) | | | | | | | | | | |
| | SF MORFREE ™899A/C99 | | | | | | | | | | |
| IE3 | MDO unblocked B//25 μm MDO- | 0.033 | 0.069 | 0.55 | 0.71 | 0.98 | 1.07 | 1.18 | 1.31 | 2.62 | 2.88 |
| | PE (HS-1) | | | | | | | | | | |
| | SF MORFREE ™899A/C99 | | | | | | | | | | |
| IE4 | MDO unblocked B//25 μm MDO- | 0.055 | 0.087 | 0.79 | 0.94 | 0.99 | 1.19 | 1.39 | 1.53 | 2.79 | 3.69 |
| | PE (HS-2) | | | | | | | | | | |
| | SF MORFREE ™899A/C99 | | | | | | | | | | |
| IE5 | MDO blockA//25 μm MDO-PE | 0.035 | 0.079 | 0.61 | 0.79 | 0.98 | 1.1 | 1.21 | 1.32 | 2.76 | 3.1 |
| | (HS-1) | | | | | | | | | | |
| | SB-ADCOTE ™545EA + Cat-F | | | | | | | | | | |
| IE6 | MDO blockA//25 μm MDO-PE | 0.050 | 0.092 | 0.78 | 0.99 | 1.15 | 1.33 | 1.41 | 1.57 | 2.93 | 3.77 |
| | (HS-2) | | | | | | | | | | |
| | SB-ADCOTE ™545EA + Cat-F | | | | | | | | | | |
| IE7 | MDO unblocked B//25 μm MDO- | 0.037 | 0.078 | 0.66 | 0.78 | 0.97 | 1.08 | 1.27 | 1.36 | 2.66 | 3.05 |
| | PE (HS-1) | | | | | | | | | | |
| | SB-ADCOTE ™545EA + Cat-F | | | | | | | | | | |
| IE8 | MDO unblocked B//25 μm MDO- | 0.051 | 0.088 | 0.79 | 0.97 | 1.25 | 1.35 | 1.43 | 1.49 | 2.98 | 3.57 |
| | PE (HS-2) | | | | | | | | | | |
| | SB-ADCOTE ™545EA + Cat-F | | | | | | | | | | |
| CS 1 | 18 μm BOPP//18 μm Heal Sealable | 0.00 | 0.00 | 0.200 | 0.230 | 0.450 | 0.450 | 0.470 | 0.500 | 0.547 | 0.60 |
| | BOPP SL-MORFREE ™899A/C99 | | | | | | | | | | |
| CS 2 | 15 μm BOPP//25 μm Heal Sealable | 0.00 | 0.00 | 0.523 | 0.879 | 1.1 | 1.13 | 1.18 | 1.44 | 1.86 | 2.1 |
| | CPP SL-MORFREE ™899A/C99 | | | | | | | | | | |

Each of IE1-IE8 unexpectedly has a seal strength of greater than 0.3 Kg/25 mm at low heat seal initiation temperature (95° C.). A heat seal strength of 0.3 Kg/25 mm at 95′C is suitable for many flexible packaging applications. Each of IE1-IE8 is composed solely of polyethylene (no polypropylene) and is compatible with polyethylene recycling streams. CS1 and CS2 each contain polypropylene (BOIPP, or biaxially oriented polypropylene) or cast polypropylene (CPP) and CS1/CS2 are not readily recyclable.

It is specifically intended that the present disclosure not be limited to the embodiments and illustrations contained herein, but include modified forms of those embodiments including portions of the embodiments and combinations of elements of different embodiments as come within the scope of the following claims.

1. A laminate comprising:
a first machine direction oriented (1MDO) multilayer film comprising
(a) a skin layer comprising
(i) a skin layer (SL) first ethylene/α-olefin copolymer having a density from 0.870 g/cc to 0.920 g/cc, and
(ii) an optional skin layer (SL) second ethylene/α-olefin copolymer having a density from 0.900 g/cc to 0.980 g/cc;
(b) a first intermediate layer in direct contact with the skin layer, the first intermediate layer comprising
(i) a first intermediate layer (FIL) first ethylene/α-olefin copolymer having a density from 0.940 g/cc to 0.980 g/cc, and
(ii) a first intermediate layer (FIL) second ethylene/α-olefin copolymer having density from 0.916 g/cc to 0.980 g/cc;
(c) a core layer in direct contact with the first intermediate layer (b), the core layer (c) comprising
(i) a core layer (CL) first ethylene/α-olefin copolymer having a density from 0.915 g/cc to 0.980 g/cc;
(d) a second intermediate layer in direct contact with the core layer, the second intermediate layer comprising an ethylene-based polymer;
(e) an interior layer in direct contact with the second intermediate layer, the interior layer comprising an ethylene-based polymer;
a second machine direction oriented (2MDO) film; and
an adhesive layer between the 1MDO multilayer film and the 2MDO film.

2. The laminate of claim 1 wherein the skin layer (a) comprises
(i) from 50 wt % to 80 wt % of the SL first ethylene/α-olefin copolymer having a density from 0.870 g/cc to 0.920 g/cc and a melt temperature from 55° C. to 125° C., and
(ii) from 50 wt % to 20 wt % of the SL second ethylene/α-olefin copolymer having a density from 0.900 g/cc to 0.920 g/cc and a melt temperature from 95° C. to 105° C., wherein weight % is based on total weight of the skin layer (a).

3. The laminate of claim 1 wherein the first intermediate layer (b) comprises
(i) the FIL first ethylene/α-olefin copolymer having a density from 0.940 g/cc to 0.950 g/cc and a melt temperature from 125° C. to 129° C.; and
(ii) the FIL second ethylene/α-olefin copolymer having a density from 0.955 g/cc to 0.980 g/cc and a melt temperature from 130° C. to 135° C.

4. The laminate of claim 1 wherein the core layer (c) comprises
(i) from 10 wt % to 50 wt % of the CL first ethylene/α-olefin copolymer having a density from 0.900 g/cc to 0.920 g/cc and a melt temperature from 120° C. to 125° C.; and
(ii) from 90 wt % to 50 wt % of the CL second ethylene/α-olefin copolymer having a density from 0.940 g/cc to 0.980 g/cc, and a melt temperature from 125° C. to 130° C., wherein the weight % is based on the total weight of the core layer (c).

5. The laminate of claim 1 wherein the second intermediate layer (d) comprises a second intermediate layer (SIL) first ethylene-based polymer having a density from 0.900 g/cc to 0.920 g/cc.

6. The laminate of claim 1 wherein the interior layer (e) comprises an interior layer (IL) first ethylene/α-olefin copolymer having a density from 0.940 g/cc to 0.980 g/cc.

7. The laminate of claim 1 wherein the 1MDO multilayer film comprises
(a) the skin layer comprising
(i) from 50 wt % to 80 wt % of the SL first ethylene/α-olefin copolymer having a density from 0.870 g/cc to 0.920 g/cc, and
(ii) from 50 wt % to 20 wt % of the SL second ethylene/α-olefin copolymer having a density from 0.900 g/cc to 0.920 g/cc, where weight % is based on the total weight of the skin layer (a);
(b) the first intermediate layer in direct contact with the skin layer, the first intermediate layer comprising
(i) the FIL first ethylene/α-olefin copolymer having a density from 0.940 g/cc to 0.980 g/cc, and
(ii) the FIL second ethylene/α-olefin copolymer having a density from 0.916 g/cc to 0.980 g/cc; and
(c) the core layer in direct contact with the first intermediate layer, the core layer comprising
(i) the CL first ethylene/α-olefin copolymer having a density from 0.900 g/cc to 0.920 g/cc, and
(ii) a CL second ethylene/α-olefin copolymer having a density from 0.940 g/cc to 0.980 g/cc, where weight % is based on the total weight of the core layer (c);
(d) the second intermediate layer in direct contact with the core layer, the second intermediate layer comprising an ethylene-based polymer; and
(e) the interior layer in direct contact with the second intermediate layer, the interior layer comprising an ethylene-based polymer.

8. The laminate of claim 1 wherein the 2MDO film is a multilayer film and comprises an outermost layer (ol) comprising an (ol) first ethylene/α-olefin copolymer having a density from 0.935 g/cc to 0.980 g/cc; and
the adhesive layer is in direct contact with the interior layer (e) of the 1MDO multilayer film and the outermost layer (ol) of the 2MDO multilayer film.

9. The laminate of claim 8 wherein the 2MDO multilayer film comprises
the outermost layer (ol);
an outer middle layer (om) in direct contact with the outer layer (ol);
a middle layer (ml) in direct contact with the outer middle layer (om);
an inner middle layer (im) in direct contact with the middle layer (ml); and
an inner layer (in) in direct contact with the inner middle layer (im).

10. The laminate of claim 9 wherein the 2MDO multilayer film is composed solely of one or more ethylene-based polymers.

11. The laminate of claim 1 wherein the 1MDO multilayer film is composed solely of one or more ethylene-based polymers.

12. The laminate of claim 1 comprising:
a first skin layer (a) in contact with a second skin layer (a);
a heat seal between the first skin layer (a) and the second skin layer (a); and
the heat seal has a heat seal strength greater than or equal to 0.3 kg/25 mm under heat seal conditions of 2.5 kg/cm² seal pressure, a 0.5 seconds dwell time, and 95° C. seal temperature.
